(19) United States
(12) Patent Application Publication
(10) Pub. No.: US 2022/0196346 A1
(43) Pub. Date: Jun. 23, 2022

(54) INTERFACE AND ASSEMBLY FOR CONNECTING REFRIGERANT TUBES IN A COOLING ASSEMBLY OF AN ELECTRICAL STORAGE DEVICE

(71) Applicant: Valeo Systemes Thermiques, Le Mesnil Saint-Denis (FR)

(72) Inventors: Aurélie Bellenfant, La Suze Sur Sarthe (FR); Fethy Djallal, La Suze Sur Sarthe (FR); Julien Veron, La Suze Sur Sarthe (FR); Marc Herry, La Suze Sur Sarthe (FR)

(73) Assignee: Valeo Systemes Thermiques, Le Mesnil Saint-Denis (FR)

(21) Appl. No.: 17/599,927

(22) PCT Filed: Mar. 26, 2020
(86) PCT No.: PCT/EP2020/058545

§ 371 Date: Sep. 29, 2021

(30) Foreign Application Priority Data
Mar. 29, 2019 (FR) FR1903358

(51) Int. Cl. F28F 9/02

(52) U.S. Cl. CPC F28F 9/0253; F28F 2230/00; F28F 9/0256

(57) ABSTRACT

The invention relates to a connection interface (20) for a connection assembly (10) for connecting refrigerant tubes in a cooling assembly of a motor vehicle electrical storage device, the connection assembly (10) comprising at least one flange (18) made integral with a heat exchange member (4), said connection interface (20) being arranged at end portions (24) of refrigerant fluid tubes to be connected to said heat exchange member, characterised in that the connection interface (20) comprises a first portion (50) integral with the end of each of the tubes (12) and a second portion (52) mounted freely around the tubes, the second portion comprising openings (64, 66) for passing the tubes dimensioned to allow a clearance for relative movement therebetween of the two portions (50, 52) of the connection interface (20), at least in a plane perpendicular to a direction of elongation of the end portions of the tubes, the connection interface (20) being configured to engage with a securing member (36) capable of setting the position of the two portions relative to each other.

The present invention relates to an assembly for cooling an electrical storage device, and more particularly connecting means employed to allow the connection of refrigerant pipes.

Electric and hybrid vehicles are equipped with at least one electrical storage device made up of an assembly of electrical modules, which are themselves made up of an assembly of electrochemical cells.

In order to ensure the autonomy, performance and reliability of such an electrical storage device, it is necessary to thermally treat the electrical storage device. Thermal treatment of the electrical storage device aims to keep the temperature of the electrical modules that make it up at a temperature of approximately between 20° C. and 40° C. This is because when the temperature of an electrical module is too low, the capacity of its electrochemical cells decreases and when the temperature of an electrical module is too high, the service life of these electrochemical cells is impaired.

To carry out this thermal treatment, it is known practice to use a cooling assembly that comprises at least one heat exchange member positioned directly in contact with an electrical module of the electrical storage device, said heat exchange member being configured to be passed through by a refrigerant.

A heat exchange member is understood to be a heat exchange plate inside which the refrigerant is forced to circulate and a plurality of these plates that are passed through successively by the refrigerant.

The refrigerant may in particular consist of 1234yf or of R134a. The refrigerant is fed into the heat exchanger by way of aluminum pipes dimensioned to allow such a refrigerant to circulate under a pressure of about six 6 bar. The pipes are configured to feed the refrigerant into the heat exchange member or if necessary to allow the refrigerant to pass from one heat exchange member to another.

In both cases, it is important to provide an appropriate connecting assembly having pipes which are fixed, at their end secured to a male connection flange, to a female connection flange secured to the heat exchanger or to a plate of this heat exchanger. More particularly, the pipes are brazed to this male connection flange and this assembly is screwed to the female connection flange.

The pipes are bent so as to meet the size constraints of the heat exchanger. Such bending of the pipes makes them fragile, in particular when the pipes extend over short distances, when stresses are exerted on the pipes.

However, a problem with connecting assemblies as have just been described is that they need to allow the mutual connection of elements, the position or configuration of which can vary from one vehicle to another on account of dimensional assembly or manufacturing clearances. Specifically, it will be understood that the position of the heat exchangers in a cooling system can vary from one system to another depending on the aggregation of dimensional variations of the components and of the assembly, and that the variation in this position from one system to another may range up to 4 to 5 mm in each direction and in one sense or the other, this being a problem in particular in the two directions perpendicular to the direction of elongation of the final portion of the pipe. Specifically, in order to be able to compensate for this dimensional variation, the male connection flange and the associated aluminum pipes need to be stressed and plastically deformed manually by the operator during assembly in order to be able to engage with the female connection flange. The effort exerted by the operator to make up for positioning defects is transferred entirely to the pipes.

As specified above, this type of manual deformation has a very negative effect for the assemblies having pipes of small size, which risk breaking. Moreover, these deformations may bring about modifications of the flow cross section for the refrigerant inside the pipes, in particular in the bent zones.

Furthermore, the assembly operations involving such deformation of the male connection flange are made complicated. These deformations add to the difficulty of the operator's work if assembly is carried out manually, and they make assembly impossible on a robotic assembly line, the robot being incapable of adapting its movements to each case as an operator would.

The present invention falls within this context and seeks to address the abovementioned drawbacks. To this end, the invention relates to a connecting interface of an assembly for connecting refrigerant pipes in a cooling assembly of a motor vehicle battery system, the connecting assembly having at least one flange secured to a heat exchange member, said connecting interface being arranged at two end portions of refrigerant pipes to be connected to said heat exchange member.

According to the invention, the interface has a first part secured to the end of each of the pipes and a second part mounted freely around the pipes, the second part having through-openings for the pipes that are dimensioned so as to give the two parts of the connecting interface clearance to move relative to one another at least in a plane perpendicular to a direction of elongation of the end portions of the pipes, the connecting interface being configured to cooperate with a fixing member that is able to fix the position of the two parts with respect to one another.

The present solution makes it possible to compensate for the variation in position of the heat exchange members while avoiding totally or partially constraining the aluminum tubes. The presence of a floating flange forming part of a connecting interface associated with the pipes makes it possible to adapt the position of this flange associated with the pipes with respect to a flange associated with a heat exchange member and makes it possible to ensure the sealing of the connecting assembly by then fixing the position of this floating flange with respect to another fixed part, forming a reference, of the interface.

As specified above, a heat exchange member is understood to be a heat exchange plate inside which the refrigerant is forced to circulate and a plurality of these plates that are passed through successively by the refrigerant.

According to various features of the invention, taken alone or in combination, it may be provided that:

the first part has a plurality of end pieces respectively fixed to one end of a pipe, each end piece having a contact surface forming a stop for the movement of the second part;

the second part has at least one fixing bore, and in that the first part is configured so as to exhibit a passage between the end pieces, the two parts being able to move relative to one another in order to take up an assembly position in which the fixing bore faces the passage between the end pieces;

each end piece has a hollow tube extending the corresponding pipe for the passage of the refrigerant, the hollow tube being able to be housed in a connecting orifice formed in the corresponding flange of the connecting assembly;

the second part has a through-orifice for a first pipe, which has a closed profile, and a through-orifice for a second pipe, which has an open profile.

The invention also relates to a connecting assembly having at least one flange secured to a heat exchange member and a connecting interface as described above, characterized in that it has a member for fixing the connecting interface in the flange, said member being configured to simultaneously press the two parts of the connecting interface against one another and the whole of this connecting interface against the connecting flange.

According to one feature of the invention, the connecting assembly has at least one clamping screw forming a fixing member, a head of which is in contact with an external face of the second part of the connecting interface and a threaded body of which is able to engage with a tapped fixing orifice in the flange, the first part of the connecting interface being disposed between the flange and the second part of the connecting interface.

As a result, the screwing in of the clamping screw tends to move the second part of the connecting interface toward the flange and thus tends to grip the first part of the connecting interface between the flange and the second part of the connecting interface. Such tightening makes it possible in particular to fix the position of the two components of the connecting interface with respect to one another.

According to one feature of the invention, the flange has at least one connecting orifice which has a receiving portion, the dimension of which in a direction perpendicular to the direction of elongation of the end portion of the corresponding pipe is greater than the corresponding dimension of the hollow tube of the end piece which is housed in this receiving portion.

According to one feature of the invention, at least one sealing device is arranged between the connecting interface and the flange, around at least one of the pipes.

The sealing device may have a metal annular reinforcement plate overmolded with an elastically deformable element, a junction zone between the deformable element and the reinforcement forming an annular bulge, said elastically deformable element being dimensioned such that this annular bulge is always gripped between the flange and the first part of the connecting interface.

Further features, details and advantages of the invention will become more clearly apparent from reading the following detailed description, and from studying several exemplary embodiments that are given purely by way of nonlimiting indication, with reference to the attached schematic drawings, in which:

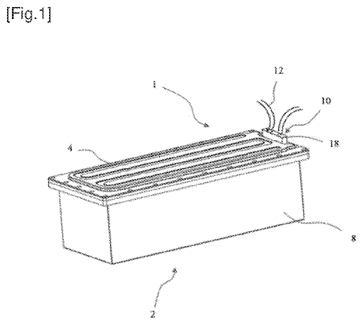

FIG. 1 schematically illustrates a heat exchange member associated with an electrical storage device, the heat exchange member being able to be equipped with a connecting assembly according to the invention;

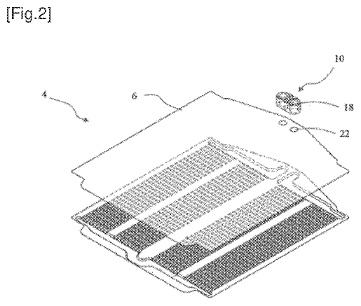

FIG. 2 illustrates an exploded depiction of an exemplary embodiment of a heat exchange member equipped with a flange forming part of the connecting assembly according to the invention;

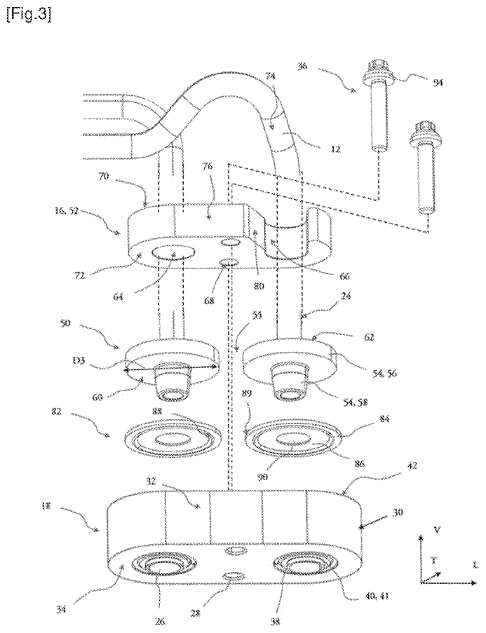

FIG. 3 illustrates an exploded depiction of the various components of the connecting assembly according to the invention, revealing in particular a flange, a sealing device, a connecting interface made of two parts and associated tubes, and fixing members;

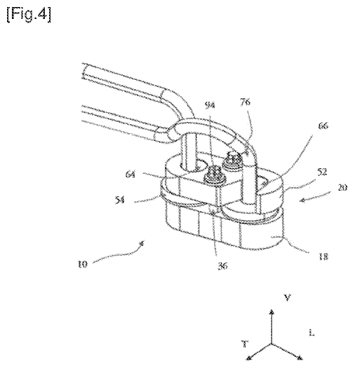

FIG. 4 illustrates a perspective depiction of the connecting assembly when the components in FIG. 3 have been assembled;

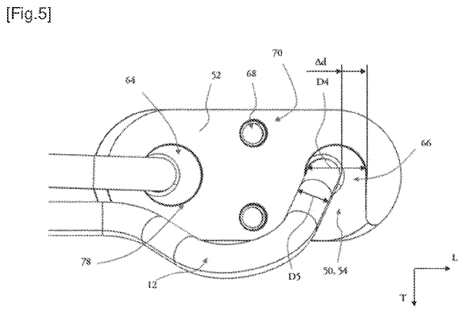

FIG. 5 illustrates a depiction of the connecting assembly in FIG. 4, in a top view;

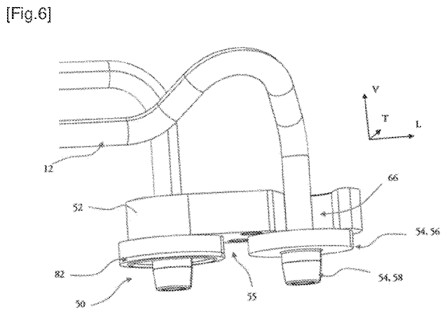

FIG. 6 illustrates the connecting interface made of two parts that can be seen in FIG. 3;

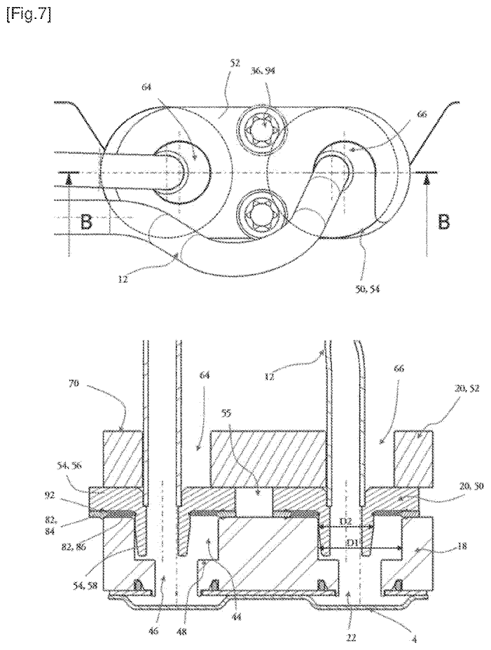

FIG. 7 illustrates the connecting assembly in a top view and a sectional view on the straight section line B-B identified in the top view;

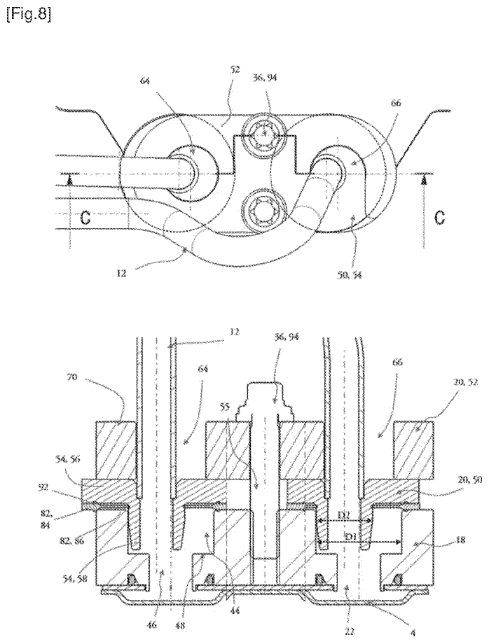

FIG. 8 illustrates the connecting assembly in a top view and a sectional view on the broken section line C-C identified in the top view;

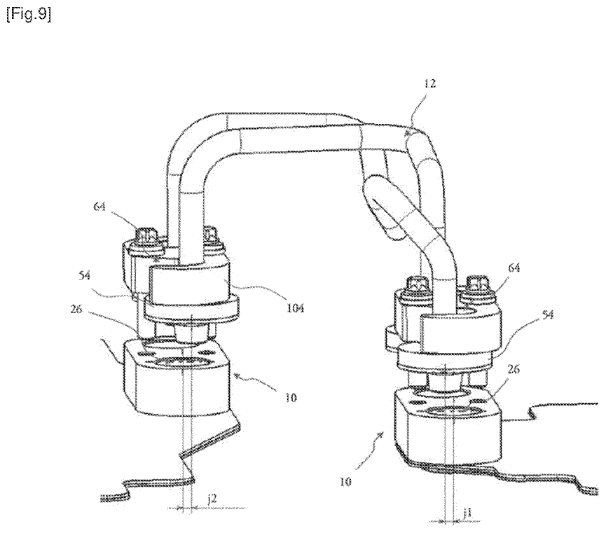

FIG. 9 is a schematic depiction of a particular application of the invention with two connecting assemblies disposed respectively at each end of a set of pipes, for connecting together two heat exchange members;

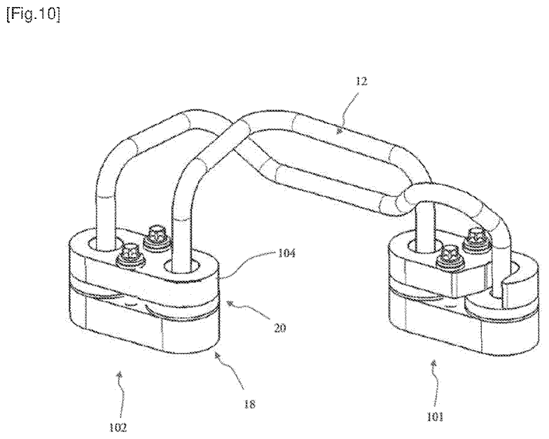

FIG. 10 is a schematic depiction illustrating both the particular application of the invention in accordance with that illustrated in FIG. 9 and a second embodiment of the previously illustrated connecting interface; and

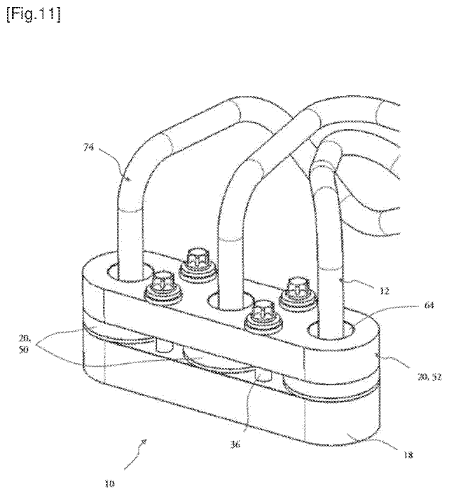

FIG. 11 is a schematic depiction of an embodiment variant of the previously illustrated connecting interface.

For the sake of clarity of the detailed description of the connecting flanges, a trihedron LVT is illustrated in FIGS. 3 to 6 so as to identify the longitudinal direction L, vertical direction V and transverse direction T.

Furthermore, the designations “first” and “second” mentioned during the description do not denote a quantitative idea but make it possible to differentiate particular elements that are present twice in the invention.

FIG. 1 illustrates a cooling assembly 1 for an electrical storage device 2. The assembly has in particular a heat exchange member 4, in this case in the form of a plate heat exchanger 6, configured to be pressed onto a housing 8 of the electrical storage device which houses for example electrochemical cells. The heat exchange member is configured to be passed through by a refrigerant, of the 1234yf or R134a type.

The cooling assembly also has a connecting assembly 10 for conducting the refrigerant toward this heat exchange member, the connecting assembly having in particular pipes 12 and flanges and interfaces arranged between these pipes and the heat exchange member.

The connecting assembly 10 according to the invention is specific in that it has at least one floating element 16, that is to say an element that is able to move so as to take up a given assembly position depending on the dimensional clearance of the elements to be connected.

More particularly, the connecting assembly 10 has a flange 18 secured to the heat exchange member 4 to which the pipes 12 are intended to be connected and a connecting interface 20 configured to be fixed to the flange, as will be described in more detail below.

FIG. 2 illustrates an exploded view of an example of a heat exchange member 4, in the form of a plate exchanger at one end of which a flange 18 is fixed next to fluid through-orifices 22. Two plates are in this case positioned facing one another and delimit between one another, by way of structures forming circulation channels, a passage for the refrigerant that enters and exits at the flange 18 after having circulated along a path extending over the entire surface of the plates.

The connecting assembly according to the invention will now be described more particularly, with reference in particular to FIGS. 3 to 8, which illustrate a first embodiment.

As described above, and as can be seen particularly in the exploded view in FIG. 3, the connecting assembly 10 has at least one plurality of pipes 12, in this case two pipes, a flange 18 secured to the heat exchange member 4 to which the two pipes are intended to be connected, and a connecting interface 20 configured to be fixed to the flange 18. Moreover, this connecting assembly 10 is specific in that this connecting interface 20 has a floating element 16.

The pipes 12 are made of bent aluminum. This results in significant rigidity of the pipes compared with the flexibility of the flexible pipes as can be used when other heat transfer fluids can be used. The pipes are in particular dimensioned to be able to withstand a pressure that can range up to around fifty bar.

At least in an end portion 24 to be connected, the pipes 12 have a substantially straight shape, i.e. a shape extending parallel to a vertically extending straight line V. This end portion extends in the direction of the flange secured to the heat exchange member.

The flange 18 is in the form of a block of material, in this case made of aluminum, secured to the heat exchange member 4, in this case by brazing, without being limited thereto. In the example illustrated, the block forming the flange has an elongate shape with a long dimension along a longitudinal axis L.

The flange 18 has at least one connecting orifice 26 for each of the pipes to be connected and at least one tapped fixing orifice 28 that is able to engage with a fixing member, in this case clamping screws 36 as illustrated in FIG. 3.

In the example illustrated, the flange has two connecting orifices 26 and two fixing orifices 28, the connecting orifices being disposed close to the longitudinal ends of the block 30 and the fixing orifices 28 being disposed substantially at the center of the block with respect to the longitudinal dimension of this block and respectively in the vicinity of a transverse edge of the flange 32.

The block forming the flange 18 has a first face 34, visible in particular in FIG. 3, that is able to be in contact with the heat exchange member 4. At least the connecting orifices 26 open out onto this first face 34. In the example illustrated, the fixing orifices 28 also open out but it should be noted that such a configuration is not limiting as long as the flange 18 is secured to the heat exchange member 4 by other means than by clamping screws made to engage with these fixing orifices. In particular, and as specified above, the flange 18 is preferably brazed to the heat exchange member and the clamping screws 36 are involved only in fixing the connecting interface 20 to the flange 18.

At the first face 34 of the flange 18, the edge delimiting each connecting orifice is continued by a collar 38 protruding from the first face, so as to form a positioning member during the fixing of the flange 18 to the heat exchange member 4.

The first face 34 of the flange 18 also has, around each connecting orifice 26, an annular groove 40 configured to receive a brazing ring 41 for brazing the flange 18 to the heat exchange member 4, as can be seen in particular in the sectional views in FIGS. 7 and 8.

The block forming the flange 18 has a second face 42 on the opposite side from the first face 34 and intended to face the connecting interface 20 when the connecting assembly is assembled. Of course, the fixing orifices 28 and the connecting orifices 26 open onto this second face 42, which can be seen at least partially in FIG. 4.

Each fixing orifice 28 is tapped and substantially straight, with a constant diameter from one face of the flange 18 to the other.

Each connecting orifice 26 has two consecutive portions 44, 46 from one face of the flange 18 to the other, these two consecutive portions having different dimensions such that a shoulder 48 is formed in the connecting orifice 26. A first portion 44 of greater dimension forms a receiving portion that extends from the second face 42 as far as the shoulder 48, this first portion 44 having the function of receiving the free ends associated with the pipes 12, by having a dimension, in this case a diameter D1, with a value greater than that of the diameter D2 of an end piece mounted on the end of the pipe 12.

As can be seen in the sectional views in FIGS. 7 and 8 in particular, the flange 18 is positioned such that the connecting orifices 26 that open onto the first face 34 of the flange are aligned vertically with respect to the refrigerant through-orifices 22 formed in the heat exchange member 4. The position of the flange 18 with respect to the heat exchange member 4 is theoretically fixed, but it will be understood that it is possible for a dimensional clearance to arise on account in particular of the assembly clearance in the aligned position of the orifices and passages and of the manufacturing clearance of the flange.

The connecting interface 20 is associated with the pipes 12 so as to allow them to be connected and held in a reliable position with respect to the flange 18 and the associated heat exchange member 4. The connecting interface 20 has, according to the invention, a first part 50 secured to the end of each of the pipes 12 and a second part 52 forming the abovementioned floating element 16, these two parts being able to move with respect to one another before the assembly of the connecting interface on the flange, this assembly helping to fix the position of these two parts of the connecting interface 20.

The first part 50 consists of at least one end piece 54 configured to be secured to each corresponding end portion of the tubes. In the example illustrated, the first part 50 of the connecting interface 20 consists of two separate end pieces 54 that are secured respectively to an end portion 24 of a pipe 12.

More particularly, the first part 50 is configured so as to exhibit a passage 55 between the end pieces 54.

Each end piece 54 is brazed to the end portion 24 of a pipe so as to form a one-piece subassembly, in that the end piece 54 and the pipe 12 cannot be separated without one or the other of them being destroyed. Each end piece has a base 56 of annular shape, which is brazed around the pipe, and a hollow tube 58 protruding from the base, at the center of the latter.

The base 56 of the end piece has a diameter with a first dimension D3 and it has a bearing surface 60 on which the hollow tube 58 is formed in a protruding manner, the bearing surface facing the end of the pipe and being intended to face the flange when the connecting assembly 10 is assembled. The base furthermore has a contact surface 62 that faces away from the bearing surface and is intended to be in contact with the second part 52 forming the floating element during the assembly of the connecting assembly.

The hollow tube 58 of the end piece vertically continues the end portion 24 of the pipe to be connected and has a substantially conical shape with a diameter that decreases with increasing distance from the base 56 so as to make it easier to insert the tube into the corresponding connecting orifice 26 of the flange 18.

The second part 52 consists of a block of material that has in this case an elongate overall shape, said block being passed through by a number of openings 64, 66 equal to the number of pipes to be connected to the heat exchange member, and by fixing bores 68, of which there are two in this case. These openings and bores are through-openings and through-bores in that they extend vertically from one face of the block forming the second part to the other.

It is possible in particular to discern on this floating element 16 formed by the second part an external face 70 facing away from the flange and an opposite internal face 72 intended to face the end pieces that form the first part 50 of the connecting interface 20.

In a similar way to the above description of the flange 18, the second part 52 of the connecting interface 20 has an elongate shape and the openings 64, 66 are disposed at each longitudinal end of the block while the fixing bores 68 are disposed at the center of the block with respect to the long dimension of the elongate shape, that is to say the longitudinal dimension, in this case respectively in the vicinity of a transverse edge of the block.

The openings 64, 66 are respectively associated with the passage of a pipe 12 through this second part 52. In order to form a floating element in particular with respect to these pipes, the openings 64, 66 have a longitudinal dimension and a transverse dimension, that is to say in the directions perpendicular to the direction of elongation of the end portion of the corresponding pipe, which are greater than the diameter of the pipes 12.

By way of example, as illustrated in FIG. 5, the longitudinal dimension D4 of the opening is greater than the diameter D5 of the corresponding pipe by a value Δd allowing displacement in this longitudinal direction. Thus, once the second part 52 of the connecting interface 20 has been fitted around the pipes 12, this second part forming the floating element 16 is allowed to move in the two directions perpendicular to the axis of elongation of the pipe at its end cooperating with the connecting interface. Furthermore, it will be understood that this second part 52 may, before the final assembly of the connecting assembly and the use of the fixing member formed here by the clamping screws 36, slide along the pipes in the vertical direction until it meets an angled portion 74 of the pipe.

In the first embodiment illustrated in FIGS. 3 to 8, the floating element 16 is in the form of a hook, with a first opening 64 which has a closed profile and a second opening 66 which has an open profile on a transverse edge 76 such that the pipe can be released from the opening via this transverse edge.

As specified above, the inside diameter D4 of the first opening 64 has a value greater than that of the diameter D5 of the corresponding pipe so as to give the floating element 16, for the one part, and the pipes 12 and the associated end pieces, for the other part, clearance to move. In addition, the edge 78 delimiting the first opening 64 forms an end-of-travel stop for the movement of the floating element 16 formed by the second part 52 with respect to the pipes 12, specifically in the two senses of the two directions perpendicular to the direction of elongation of the end portion 24 of the corresponding pipe.

As illustrated in FIG. 3, the second opening 66 opens onto a transverse edge 76 of the block. In other words, a slot 80 is formed in the continuation of the second opening from this transverse edge, the flow cross section being increased in the slot 80 compared with the second opening 66.

As a result of this hook-shaped form, the second part 52 of the connecting interface 20 is able to pivot about an axis formed by the linear contact between the first opening 64 having a closed profile and the corresponding pipe 12. It is thus possible to pivot the floating element 16 once the latter has been fitted around the pipes 12, during an assembly step in which the end pieces need to be brazed onto the pipes.

The connecting assembly 10 also has a plurality of seals forming a sealing device 82 at the junction between the flange 18 and the connecting interface 20. These seals are particularly visible in FIG. 3 in an exploded view, and in FIGS. 6 to 8. To illustrate the installation of a seal between the flanges, just one of these seals has been illustrated in FIG. 6.

Each seal is a flat seal having an annular metal reinforcement 84 and an elastically deformable element 86, of the rubber type, arranged on the internal perimeter 88 of the annular reinforcement. The deformable element has a hole at its center, this hole 90 being dimensioned to be able to be fitted around the tube 58 protruding from the end piece 64 secured to the end of a pipe 12. The elastically deformable element 86 is overmolded on the metal reinforcement and a junction zone between the elastically deformable element 86 and the metal reinforcement 84 forms an annular bulge 92.

In order to ensure sealing in spite of the end pieces moving in the two directions perpendicular to the direction of elongation of the pipes, each flat seal is oversized with an internal part formed by the elastically deformable element 86 which is large enough for the annular bulge 92 to always be gripped between the flange 18 and the corresponding end piece 54.

The clamping screws 36 forming the fixing member are dimensioned so as to pass through the second part 52 of the connecting interface, respectively through one of the fixing bores 68, and to engage with a tapped fixing orifice 28 formed in the flange 18, with a screw head 94 which is able to bear on the external face 70 of the floating element formed by the second part 52 of the connecting interface 20. It will be understood that when the screws are tightened, the floating element is pushed by the screw head 94 against the first part 50 of the connecting interface 20 and this assembly is simultaneously pressed against the flange 18, simultaneously trapping the seals that form the sealing device 82 between the flange 18 and the connecting interface 20 and preventing the relative movement between the two parts 50, 52 of the connecting interface.

A connecting method will now be described in order to illustrate the advantage of the invention of having at least two independent pipes, in contrast to the prior art solutions in which each pipe is directly brazed to a flange configured to be welded or screwed to a corresponding flange of the heat exchange member.

First of all, the flange 18 is secured to the heat exchange member 4, for example by brazing. As can be seen in FIGS. 7 and 8, the flange 18 is, to this end, positioned with respect to the heat exchange member 4 and the through-orifices 22 through which the refrigerant needs to enter the plates that in this case form the heat exchange member, the positioning members 38 that protrude from the first face 34 of the flange 18 being inserted into the through-orifices. The flange thus takes up a fixed position, with a center-to-center distance between the through-orifices.

Next, the connecting interface 20 associated with the pipes 12 will be fixed to the flange 18, ensuring that the center-to-center distance between the pipes 12 and the end pieces 54 that extend them is equal to the center-to-center distance between the through-orifices 22, in order not to have to exert forces on the pipes to force them to enter.

In a first step, each of the parts of the connecting interface is positioned with respect to the pipes. The floating element 16 formed by the second part 52 is first of all fitted around the pipes 12. In the example illustrated, in which the floating element is in the form of a hook, only the first opening 64 having the closed circular profile is fitted around a pipe 12. The floating element is slid along the pipe(s) so as to clear the end portion of each pipe.

The hook shape may make it possible to pivot the floating element 16 about the first opening 64, in particular when the bend of the pipes 12 does not allow this floating element to be sufficiently lifted to clear the end of the pipes and allow the end pieces to be brazed to these ends.

Then, the end pieces 54 are secured, in this case by brazing or alternatively for example by adhesive bonding, to the end portion 24 of the pipes 12. The tubes 58 of the end pieces 54 form a protrusion extending the pipes, away from the latter. Finally, the seals forming a sealing device 82 are respectively fitted around the tubes 58 of the end pieces 54.

In a second step, it is then necessary to fix the connecting interface 20 to the flange 18. First of all, each of the end pieces 54 is positioned in the connecting orifices 26 opening onto the second face 42 of the flange, and therefore more particularly in the receiving portion 44 of each connecting orifice 26.

The advantage of having independent pipes, that is to say pipes respectively secured to their own end piece and not to a solid flange common to all the pipes, is that it is possible to manage the installation of the pipes independently of one another. Thus, the lack of parallelism of one heat exchange member with respect to the other can be compensated for by independently positioning each pipe and its associated end piece in the receiving portion that corresponds to it. It is thus possible to make the center-to-center distance between the pipes and the center-to-center distance between the connecting orifices correspond, by moving each pipe independently, without having to exert force on the pipes to move them apart or toward one another in order to adapt to the center-to-center distance between the connecting orifices.

Furthermore, the fact that the receiving portions of each orifice have dimensions greater than those of each end piece allows each end piece to shift in directions perpendicular to the axis of elongation of the pipes once installed in the orifices of the flange, and this makes it possible to compensate for the positioning defect of the heat exchange members intended to be connected.

The fact that the second part of the connecting interface forms a floating element that is not yet secured to the end pieces with openings with dimensions greater than those of the pipes allows these pipes to move inside the openings and to be able to take up, in an unimpeded manner, a position aligned vertically with the connecting orifices.

During this positioning of the connecting interface on the flange, the seals are positioned against the second face of the flange. As specified above, the seals are dimensioned such that the bulge forming the junction between the metal reinforcement and the elastically deformable material of the rubber type is in contact with the second face of the flange, even in an extreme position of the end pieces against an edge delimiting the first portion of the corresponding connecting orifice, as illustrated in FIGS. 7 and 8.

In a last step, the two parts 50, 52 forming the connecting interface 20 are secured together by screwing the clamping screws 36 into the flange 18. For this purpose, it is necessary that the floating element 16 formed by the second part 52 of the connecting interface be moved in the longitudinal and transverse plane, perpendicularly to the direction of elongation of the pipes, in order to vertically align each of the fixing bores 68 of the floating element of the connecting interface 20 with the fixing orifices 28 of the flange 18.

In this positioning of the two parts of the connecting interface that are able to move with respect to one another in order to take up an assembly position in which each fixing bore 68 faces a fixing orifice 28, it should be noted that the second part 52 forming the floating element is also positioned such that each fixing bore 68 of the second movable part faces the passage 55 formed between the end pieces 54 in the region of the fixed first part 50 in order to be able to allow the insertion of the clamping screws 36.

In other words, the connecting assembly 10 is configured such that, in this aligned position of the bores 68 and orifices 28, which can be seen in particular in FIGS. 5, 7 and 8, the seals forming a sealing device 82 are dimensioned such that the external peripheral contour 89 of the metal reinforcement is flush with the shanks of the clamping screws 36 without impairing the tightening thereof, even in an extreme position of the end pieces (shown by way of dotted lines in FIGS. 7 and 8) in the corresponding receiving portion of the flange.

The tightening of the screw involves the screw head 94 bearing on the external face 70 of the second part of the connecting interface and, as explained above, this second part 52 of the connecting interface in turn being pressed against the first part 50 of the connecting interface and this first part 50 of the connecting interface being pressed against the flange 18. This tightening means that the annular bulge 92 of the seals forming a sealing device 82 is gripped between the flange and the connecting interface, this tending to compress the elastically deformable element 86 against the tube 58 of the corresponding end piece 54 and thus tending to ensure the sealing of the connecting assembly. The floating part 16 forming the second part 52 of the connecting interface is thus placed on top of the end pieces 54 forming the first part 50 of the connecting interface 20 so as to bear on these end pieces and compress the seals in order to ensure the sealing with respect to the passage of fluid while allowing the pipes 12 to move within this floating part 16 in order to compensate for the positioning defect between the pipes 12 and flange 18 secured to the heat exchange member.

Different variants and embodiments will now be described with reference to FIGS. 9 to 11.

FIG. 9 is a schematic depiction of a particular application of the invention with two connecting assemblies disposed respectively at each end of a set of pipes, for connecting together two heat exchange members. In other words, each of the pipes is equipped with a connecting assembly at each of its end portions. In the example illustrated, the connecting assemblies are identical and take the form of a connecting assembly 10 as described above. Such an application with two connecting assemblies is provided in particular for cooling systems in which a plurality of heat exchange members are arranged in series and pipes are disposed between two successive heat exchange members.

By way of a different viewing angle, this FIG. 9 also reveals the advantage of oversizing the openings 64 in the floating element with respect to the corresponding dimensioning of the pipes 12. In the above illustration, examples were featured in which the movement of the pipe in the corresponding orifice was primarily longitudinal in order to allow longitudinal play compensation. The example illustrated in FIG. 9 shows a practical case in which, for a first connecting assembly, the end pieces 54 disposed in the continuation of the pipes are offset by a clearance j1 with respect to the axis of revolution of the connecting orifices 26 in a first sense with respect to the transverse direction and in which, for the second connecting assembly, the end pieces 54 disposed in the continuation of the pipes are offset by a clearance j2 with respect to the axis of revolution of the connecting orifices 26 in a second, opposite sense with respect to the transverse direction. The possibility of moving each pipe in translation in the corresponding orifice 64 formed in the floating element of the connecting interface makes it possible to adjust the alignment of the end pieces in the connecting orifices, and then to reposition the floating element without constraining the pipes in order to align the bores and the fixing orifices.

FIG. 10 also illustrates the particular application with two connecting assemblies disposed respectively at each end of a set of pipes, for connecting together two heat exchange members. This FIG. 10 also illustrates a second embodiment in which a first connecting assembly 101 is in accordance in every aspect with what has been described above in the first embodiment and in which, at the other end of the pipes, a second connecting assembly 102 differs from the first connecting assembly by way of the shape of the floating element of the connecting interface 20.

More particularly, the floating element of the second connecting assembly is no longer hook-shaped with an orifice having an open profile, but forms a floating flange 104 with two orifices having a closed profile. It will be understood that this second connecting assembly may have two orifices having a closed profile since the bending of the pipes is substantially the same from one pipe to the other in the vicinity of this second connecting assembly. Thus, the disposition of the pipes allows sufficient movement of the floating element, such that the pivoting of the floating element and therefore the hook shape is not necessary.

The assembly method is the same as that described above, but such a floating element can only be employed if the shape of the two pipes allows sufficiently long clearance in translation of the floating element to allow the end pieces to be brazed to the flange.

FIG. 11 illustrates an embodiment variant in which the connecting assembly 10 is configured to allow three pipes to be connected to the heat exchange member rather than two pipes as described above. The connecting assembly has the same configuration as that described above for the second connecting assembly in FIG. 10, namely the connecting assembly with the flange 18 and the connecting interface 20, the second part 52 of which forming the floating element is equipped with openings 64 having a closed profile.

As a result of this configuration, the pipes 12 need to have a first angled portion 74 sufficiently far away from their free end to allow the floating element to be slid along the pipes. In addition, it should be noted that the number of fixing members, in this case of clamping screws 36, is greater on account of the increase in the longitudinal dimension of the flange and of the corresponding connecting interface.

Of course, the number of end pieces secured independently to each of the ends of the pipes passing through an opening 64 of the floating element is also increased, remaining the same as the number of pipes, i.e. in this case equal to three.

As a result of the above description, an advantage of the invention is that of allowing simple assembly with little if any effort, while avoiding constraining the pipes to an extent risking damaging them. The use of a connecting assembly as described above according to the two embodiments or any combination of these two embodiments is all the more advantageous the shorter the pipes, given that it is all the harder to constrain them without damaging them.

The invention is not limited to the means and configurations described and illustrated herein, however, and also extends to all equivalent means or configurations and to any technically operational combination of such means. In other words, the two embodiments that are described above are entirely nonlimiting; it will be possible, in particular, to imagine variants of the invention that comprise only a selection of the features described below, in isolation from the other features described in this document, as long as this selection of features is sufficient to confer a technical advantage or to distinguish the invention from the state of the art.

1. A connecting interface of an assembly for connecting refrigerant pipes in a cooling assembly of a motor vehicle electrical storage device, the connecting assembly comprising:
at least one flange secured to a heat exchange member, said connecting interface being arranged at end portions of refrigerant pipes to be connected to said heat exchange member,
wherein the connecting interface has a first part secured to the end of each of the pipes and a second part mounted freely around the pipes, the second part having through-openings for the pipes that are dimensioned so as to give the two parts of the connecting interface clearance to move relative to one another, at least in a plane perpendicular to a direction of elongation of the end portions of the pipes,
the connecting interface being configured to cooperate with a fixing member that is able to fix the position of the two parts with respect to one another.

2. The connecting interface as claimed in claim 1, wherein the first part has a plurality of end pieces respectively fixed to one end of a pipe, each end piece having a contact surface forming a stop for the movement of the second part.

3. The connecting interface (20) as claimed in claim 2, wherein the second part has at least one fixing bore, and in that the first part is configured so as to exhibit a passage between the end pieces, the two parts being able to move relative to one another in order to take up an assembly position in which the fixing bore faces the passage between the end pieces.

4. The connecting interface as claimed in claim 2, wherein each end piece has a hollow tube extending the corresponding pipe for the passage of the refrigerant, the hollow tube being able to be housed in a connecting orifice formed in the corresponding flange of the connecting assembly.

5. The connecting interface as claimed in claim 1, wherein the second part has a first through-opening for a first pipe, which has a closed profile, and a through-opening for a second pipe, which has an open profile.

6. A connecting assembly comprising:
at least one flange secured to a heat exchange member;
a connecting interface as claimed in claim 1; and,
a member for fixing the connecting interface in the flange, said member being configured to simultaneously press the two parts of the connecting interface against one another and the whole of this connecting interface against the flange.

7. The connecting assembly as claimed in claim 6, wherein has at least one clamping screw forming a fixing member, a head of which is in contact with an external face of the second part of the connecting interface and a threaded body of which is able to engage with a tapped fixing orifice in the flange, the first part of the connecting interface being disposed between the flange and the second part of the connecting interface.

8. The connecting assembly as claimed in claim 6 wherein the flange has at least one connecting orifice which has a receiving portion, the dimension of which in a direction perpendicular to the direction of elongation of the end portion of the corresponding pipe is greater than the corresponding dimension of a hollow tube of the end piece extending the corresponding pipe for the passage of the refrigerant which is housed in the receiving portion.

9. The connecting assembly as claimed in claim 6 at least one sealing device is arranged between the connecting interface and the flange, around at least one of the pipes.

10. The connecting assembly as claimed in claim 9, wherein the sealing device has a metal annular reinforcement plate overmolded with an elastically deformable element, a junction zone between the deformable element and the reinforcement forming an annular bulge, said elastically deformable element being dimensioned such that this annular bulge is always gripped between the flange and the first part of the connecting interface.
